(19) United States
(12) Patent Application Publication
(10) Pub. No.: US 2026/0365399 A1
(43) Pub. Date: Nov. 19, 2026

(54) Multi-Packaging Carrier Based On Post-Consumer Recycled Polyolefins

(71) Applicant: Illinois Tool Works Inc., Glenview, IL (US)

(72) Inventors: Christopher J. Samaras, Tinley Park, IL (US); Saeid Nikafshar, Hinsdale, IL (US)

(73) Assignee: Illinois Tool Works Inc., (omitted)

(21) Appl. No.: 19/410,890

(22) Filed: Dec. 5, 2025

Related U.S. Application Data
(60) Provisional application No. 63/734,055, filed on Dec. 14, 2024.

(51) Int. Cl. B65D 71/50; C08K 3/34; C08K 5/20; C08L 23/06

(52) U.S. Cl. CPC B65D 71/504; C08K 3/34; C08K 5/20; C08L 23/06; C08L 2205/025; C08L 2205/08; C08L 2207/066; C08L 2207/20

(57) ABSTRACT

A flexible carrier for carrying a plurality of containers, such as soft drink and other beverage containers, is formed from a polymer composition which in based entirely or almost entirely on a post-consumer recycled polymer blend, a compatibilizer, and a slip agent. The compatibilizer homogenizes and reduces rheological disparities between the recycled polyethylene components and the impurities present in the post-consumer recycled polymer blend and provides the carrier with improved strength, high-speed stretch, and elastic recovery during and after the rigorous installation process used to combine the flexible carrier with the containers. The slip agent helps prevent the container carrier from sticking to the containers after the installation process. By bringing the physical properties of the recycled polymers closer to those of otherwise similar virgin polymers, the flexible carrier enables the use of higher amounts of post-consumer recycled polymer than have previously been used successfully in this process.

### RELATED APPLICATIONS

This patent application claims priority to U.S. Provisional Application Ser. No. 63/734,055, filed on Dec. 14, 2024, the disclosure of which is incorporated by reference.

### FIELD OF THE INVENTION

This invention relates to a multi-packaging container carrier that is substantially or entirely based on post-consumer recycled polyolefins.

### BACKGROUND OF THE INVENTION

Conventional container carriers are often used to unitize a plurality of similarly sized containers, such as cans, bottles, jars and boxes and/or similar containers that require unitization. Flexible plastic ring carriers are one such conventional container carrier. Flexible plastic ring carriers having a plurality of container receiving apertures, typically of a generally oval, round, or rectangular configuration, that each engage a corresponding container may be used to unitize groups of four, six, eight, twelve or other suitable groups of containers into a convenient multipackage.

U.S. Pat. No. 11,845,599, issued on Dec. 19, 2023, describes a flexible container carrier formed using a polymer blend that includes about 30-80% by weight of a low density polyethylene, about 20-70% by weight of a post-consumer recycled plastic blend of low density polyethylene and linear low density polyethylene, and one or more additives for improving the manufacturing characteristics and/or post-consumer characteristics such as reduced degradation. Post-consumer recycled plastics (“PCRP's”) are derived from end products, such as plastic containers, flexible container carriers, plastic bags and other plastic products that have completed their initial lifecycles as consumer products and can be recycled instead of being disposed of.

U.S. Pat. No. 12,031,018, issued on Jul. 9, 2024, discloses a flexible container carrier that enables the use of a broader range of about 10-95% by weight of a post-consumer recycled blend, zero to about 90% by weight of a branched low density polyethylene that has not been recycled, and greater that zero to about 65% by weight of an elastomeric ethylene polymer of ethylene and vinyl acetate. The elastomeric ethylene polymer compatibilizes and strengthens the blend, hence enabling the broader range of recycled polymers.

However, because post-consumer recycled polymer blends (PCRP's) contain minor amounts of impurities, and generally have less strength and elastic recovery that otherwise similar virgin polymers that have not previously been used or recycled, it has not been possible to provide suitable multi-packaging container carrier made entirely of post-consumer recycled polyolefin blends for use in the rigorous stretch-and-recovery process that combines the container carriers with the containers. This is due in part to the rigors of high-speed application of the container carriers to the containers. A container carrier that includes post-consumer recycled polyolefins must also, when installed to containers, create a sturdy and aesthetically pleasing package that meets end-use performance requirements without breakage, sagging at the ends, or container loss.

Although the increased use of PCRP's in multi-pack carriers is environmentally and economically friendly, using PCRP's alone has resulted in the loss of elastic recovery when the carriers are stretched to enable insertion of the containers into the apertures. Prolonged stretch of the carriers is detrimental to the manufacturing process because it slows down the container installation process and, in some cases, allows the containers to spontaneously dislodge after being installed. Maintaining a relatively short recovery time is vital for efficiently securing the containers in the carriers and restarting the installation process for the next subsequent carriers.

There is thus a need or desire for flexible plastic container carriers that are formed entirely, or almost entirely of PCRP's while maintaining standard, relatively short and efficient elastic recovery times during installation of the containers.

### SUMMARY OF THE INVENTION

The present invention provides a flexible carrier for packaging a plurality of containers that includes a flexible sheet formed from at least about 97%, suitably at least about 98% or at least about 99%, and up to about 100% by weight of a PCRP blend. The flexible carrier is of the type where the containers each have a first outer diameter and circumference, and the flexible sheet includes a plurality of primary apertures designed to facilitate engagement between the flexible carrier and the containers. Prior to the engagement, the apertures have a second inner diameter and/or circumference that is smaller than the first outer diameter and/or circumference of the containers. Using the high-speed process described above, the flexible carrier surrounding the primary apertures is stretched to enlarge the primary apertures, so that the primary apertures can be positioned around the containers. The flexible carrier surrounding the primary apertures is then allowed to recover, providing a tight engagement between the flexible carrier and the containers within the primary apertures.

In order to enable the PCRP blend to provide the needed strength, stretch and recovery properties, the PCRP blend should be substantially pure and can include a blend of recycled branched low density polyethylene and recycled linear low density polyethylene. The phrase “substantially pure” is intended to mean that the recycled branched low density polyethylene and the recycled linear low density polyethylene constitute at least about 97% by weight of the PCRP blend, suitably at least about 98% by weight of the PCRP blend, or at least about 99% by weight of the PCRP blend. In other words, any impurities in the PCRP blend constitute not more than about 3% by weight of the blend, suitably not more than about 2% by weight of the blend, or not more than about 1% by weight of the blend.

In order to further enable the PCRP blend to provide the needed strength, stretch and recovery properties, the PCRP blend can be provided with a compatibilizer that homogenizes the recycled branched low density polyethylene and the recycled branched linear low density polyethylene with each other and with the impurities that are present. In so doing, the strength, stretch and recovery properties of the PCRP bend approach those of those achieved with otherwise similar blends of virgin (not previously used or recycled) blends of branched low density polyethylene and branched linear low density polyethylene, which virgin blends are free of impurities.

Suitable compatibilizers include without limitation those based on polyamide, polypropylene, and/or anhydride-modified polyethylene, with polyamide 12 being particularly suitable. The compatibilizer can be present at about 1000 ppm to about 10,000 ppm based on the weight of the PCRP blend.

In order to further facilitate ease of engagement between the flexible carrier and the containers within the primary apertures, the PCRP blend can also be provided with a blooming slip agent. Suitable blooming slip agents include without limitation slip agents based on erucamide. The blooming slip agent can be present at about 100 ppm to about 3000 ppm of the PCRP blend.

The PCRP blend can optionally include up to about 5000 ppm of an antioxidant and/or up to about 2500 ppm of an antiblock agent.

With the foregoing in mind, it is a feature and advantage of the invention to provide a flexible container for carrying a plurality of containers. The flexible carrier includes a flexible sheet, and a plurality of primary apertures formed in the sheet for receiving portions of the containers. The flexible sheet is formed of a polymer composition that includes:
about 97% to about 100% by weight of a PCRP blend that includes recycled branched low-density polyethylene and recycled linear low-density polyethylene polymers;
about 1000 ppm to about 10,000 ppm of a compatibilizer;
about 100 ppm about 3000 ppm of a blooming slip agent; and
zero to about 5000 ppm of an antioxidant; and
zero to about 2500 ppm of an antiblock agent.

In another embodiment, it is a feature and advantage of the invention to provide a flexible container for carrying a plurality of containers. The flexible carrier includes a flexible sheet, and a plurality of primary apertures formed in the sheet for receiving portions of the containers. The flexible sheet is formed of a polymer composition that includes:
about 98% to about 100% by weight of a PCRP blend that includes about 40% to about 70% by weight recycled branched low-density polyethylene and about 30% to about 60% by weight recycled linear low-density polyethylene, the recycled branched low-density polyethylene and recycled linear low-density polyethylene together constituting at least about 98% by weight of the PCRP blend;
about 1000 ppm to about 10,000 ppm of a compatibilizer;
about 100 ppm about 3000 ppm of a blooming slip agent; and
zero to about 5000 ppm of an antioxidant; and
zero to about 2500 ppm of an antiblock agent.

In another embodiment, it is a feature and advantage of the invention to provide a flexible container for engaging and carrying a plurality of containers having a first diameter. The flexible carrier includes a flexible sheet having a plurality of primary apertures having a second diameter that is smaller than the first diameter prior to the engaging. The flexible sheet is formed of a polymer composition that includes:
about 97% to about 100% by weight of a PCRP blend that includes about 40% to about 70% by weight recycled branched low-density polyethylene and about 30% to about 60% by weight recycled linear low-density polyethylene;
about 1000 ppm to about 10,000 ppm of a compatibilizer selected from at least one of a polyamide, polypropylene, and anhydride-modified polyethylene;
about 100 ppm about 3000 ppm of a blooming slip agent;
zero to about 5000 ppm of an antioxidant; and
zero to about 2500 ppm of an antiblock agent.

The foregoing and other features and advantages of the invention will become further apparent from the following detailed description of the invention, read in conjunction with the accompanying drawings.

### BRIEF DESCRIPTION OF THE DRAWING

FIG. 1 is a side elevational view of a container carrier according to one exemplary embodiment of this invention.

### DETAILED DESCRIPTION OF THE INVENTION

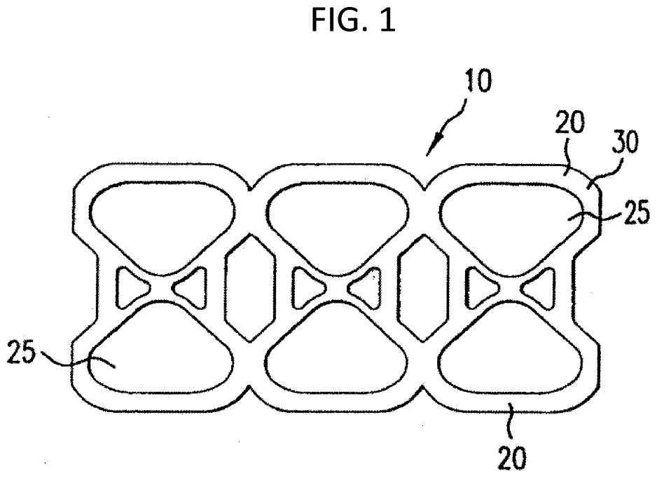

FIG. 1 shows a flexible carrier 10 for unitizing multiple containers into a resulting unitized package. Although FIG. 1 illustrates a carrier having six container receiving apertures 25, the illustration is exemplary, and the invention is not limited to the flexible carrier shown for six containers. For example, the flexible carrier 10 may be alternatively configured and used to unitize two, four, six, eight, ten, twelve, or any other desired number of containers.

The containers can be cans or bottles, however any other commonly unitized containers may be used with flexible carrier 10 according to this invention. The containers are preferably, though not necessarily, like-sized within a single flexible carrier.

Each flexible carrier 10 can include a single layer of flexible sheet 20 having a width and length defining therein a plurality of container receiving primary apertures 25, each for receiving a container. The plurality of container receiving apertures can be arranged in two longitudinal rows and multiple longitudinal ranks to form an array of container receiving apertures, such as two rows by three ranks for a six container multipackage as shown in FIG. 1. Container receiving apertures 25 are preferably generally slightly elongated in a longitudinal direction of flexible carrier 10. The container receiving apertures 25 and intermediate (smaller) apertures are suitably formed in a geometry that results in a uniform application of the carrier to the containers.

Prior to stretching the flexible carrier 10, and engaging the containers, the primary apertures 25 each have a first internal diameter and/or a first internal circumference. The containers have a second outer diameter, and/or a second outer circumference, which is larger than the first diameter and/or the first internal circumference. In the illustrated embodiment, the primary apertures 25 have convex edges formed in the flexile sheet 20 for receiving a external portion of the containers by stretching the flexible carrier 10 surrounding the primary apertures 25 around the containers and allowing the flexible carrier surrounding the primary apertures 25 to recover, providing a tight engagement with the containers within the primary apertures 25. As explained above, the engagement of multiple containers within the primary apertures 25 is a high-speed process that exposes the flexible carrier 10 to rigorous stresses, thus requiring the flexible carrier to be made of a material that can withstand the rigorous stretch, recovery, and strength required for the application.

A representative package resulting from flexible carrier includes a plurality of unitized containers and can, for example include containers. The number of primary apertures 25 in each flexible carrier 10 should correspond with the number of containers and can for example be two, four, six, eight, ten, twelve, fourteen, sixteen, eighteen, twenty, twenty-two, or twenty-four. In order for the flexible carrier 10 to be applied to containers by stretching portions of the flexible sheet surrounding the container receiving apertures 25 around the containers and permitting the stretched carrier to recover tightly against the containers, the container material must be able to withstand high-speed stretching, deliver strong and high-speed recovery, and withstand subsequent use without sagging and losing the containers. Efficient elastic recovery of the stretched carrier is important in order to enable the resulting container assembly to be moved from the processing machine and stored, making way for the subsequent batch of containers to be installed in a subsequent flexible carrier 10.

The flexible carriers 10, such as shown in FIG. 1, are manufactured in a generally continuous string of carriers wherein the carriers are punched or otherwise formed longitudinally adjacent to other carriers. In this manner, a generally continuous string of carriers is formed that may be rolled onto reels or folded into boxes for later unwinding and application to containers. The carriers are then cut into individual carriers and packages. The containers to be inserted in the container receiving apertures 25 may have varying shapes and diameters. Referring to FIG. 1, for instance, each flexible carrier 10 can be installed on containers by stretching the carrier receiving portions 30 in the cross direction, in opposing fashion. The subsequent recovery of the carrier receiving portions 30 provides the snug fit around the rib, chime or outside surface of the containers whose strength is impacted, in part, by the modulus and elastic recovery of the flexible sheet 20 used to construct the flexible carrier 10. The plan view dimensions of the flexible carrier 10, and its components, vary according to the end use. Particular end uses include without limitation soft drink and beverage cans and bottles of many sizes and shapes.

The flexible sheet 20 used to form the flexible container carrier 10 is desirably a plastic film, which can be formed by an extrusion process and then cut to form the flexible carrier. The flexible sheet 20 has a thickness which provides sufficient structural integrity to carry a desired number of containers. For instance, each flexible carrier 10 may be designed to carry multiple containers of a desired product having a specific weight, volume, shape, and size. For most applications, the flexible sheet 20 may have a thickness of about 3-50 mils, suitably about 5-30 mils, commonly about 10-20 mils.

In accordance with the invention, the flexible sheet 20 used to form the flexible carrier 10 is formed using a PCRP polymer composition that provides the carrier 10 with a desirable recovery after stretch, and suitable elongation and strength at break. Elongation at break and strength at break are measured using the stress-strain test described in ASTM D882-91, which procedure is incorporated by reference. The PCRP polymer composition can include at least about 97% PCRP components, or at least about 98% PCRP components, or at least about 99% PCRP components, and up to about 100% PCRP components, based on the weight of the PCRP polymer composition. Recovery after stretch can be measured using various standard and specialized procedures.

The polymer composition used to form the flexible carrier can be a PCRP that includes recycled branched low-density polyethylene and/or recycled linear low-density polyethylene polymers. The polymer composition can be a blend that includes about 40% to about 70% by weight recycled branched low density polyethylene and about 30% to about 60% by weight recycled linear low density polyethylene. The polymer composition can be a blend that includes about 50% to about 60% by weight recycled branched low density polyethylene and about 40% to about 50% by weight recycled linear low density polyethylene. The polymer composition can be a blend that includes about 60% to about 70% by weight recycled branched low density polyethylene and about 30% to about 40% by weight recycled linear low density polyethylene.

The recycled branched low-density polyethylene in the PCRP blend can be a high-pressure polyethylene homopolymer or ethylene-alpha olefin copolymer and is suitably a homopolymer. Its density may vary from about 0.910 to about 0.950grams/cm³, suitably about 0.915 to about 0.940 grams/cm³, or about 0.920 to about 0.935 grams/cm³. When the branched low-density polyethylene is a copolymer, its density will vary depending on the amount and type of ethylene-alpha olefin comonomer. The comonomer can be a C₃ to C₁₂ alpha-olefin, suitably a C₄ to C₈ alpha-olefin and can constitute from zero to 20% by weight, suitably zero to 10% by weight of the recycled branched low-density polyethylene polymer.

The recycled linear low-density polyethylene in the PCRP blend can be a low-pressure ethylene-alpha olefin copolymer having a density from about 0.910 to about 0.950 grams/cm³, suitably about 0.915 to about 0.940 grams/cm³, or about 0.920 to about 0.935 grams/cm³. Its density will vary depending on the amount and type of ethylene-alpha olefin comonomer. The comonomer can be a C₃ to C₁₂ alpha-olefin, suitably a C₄ to C₈ alpha-olefin and can constitute from about 2 to 20% by weight, suitably about 3 to 10% by weight of the branched low-density polymer.

In order to ensure smooth processing, stretch and recovery, the recycled branched low-density polyethylene and the recycled linear low density polyethylene can each have a melt index of about 0.2 to 3.0 grams/10 min., suitably about 0.3 to 1.5 grams/10 min., or about 0.4 to 0.7 grams/10 min., measured at 190 °C using ASTM D1238. If either of the components does not have a met index within a desired range, then the overall PCRP blend, representing the combination of the recycled branched low-density polyethylene and the branched linear low density polyethylene, should be tailored to have a melt index within the desired range of about 0.2 to 3.0 grams/10 min., suitably about 0.3 to 1.5 grams/10 min., or about 0.4 to 0.7 grams/10 min.

As explained below, the PCRP blend can also include a compatibilizer, and blooming slip agent, and optionally an antioxidant and/or an antiblock agent. Aside from these components, the PCRP blend should have minimal impurities, broadly defined as unwanted polymers, inorganic fillers, and monomers that are contained within the PCRP blend, exclusive of the compatibilizer, blooming slip agent, antioxidant and/or antiblock agent. The PCRP blend should include not more than about 3% impurities, suitably not more than about 2% impurities, or not more than about 1% impurities, based on the weight of the PCRP blend.

Nevertheless, the PCRP blend will likely contain at least some impurities that, if left unaddressed, would compromise the strength stretch, and/or recovery properties of the flexible container carrier 10. In order to address the impurities in the PCRP blend, the polymer composition used to form the flexible sheet 20 also includes a compatibilizer that homogenizes the recycled polyethylene components with the impurities in the PCRP blend and better homogenizes the recycled polyethylene components with each other by reducing rheological variations. Suitable compatibilizers include those based on polyamides, polypropylene, and anhydride-modified polyethylene. One suitable polyamide-based compatibilizer is a polyamide 12 compatibilizer having a narrow particle size distribution, sold under the name ORGASOL® 2002 EXD NAT 1, by Arkema Global. One suitable polypropylene-based compatibilizer is sold under the name VISTAMAXX® 6202 by ExxonMobil Chemical Co. Another suitable polyethylene-based compatiblizer is a maleic anhydride modified polyethylene sold under name BONDYRAM® 5101, by Polyram Plastic Industries LTD. The amount of compatibilizer in the polymer composition used to form the flexible sheet 20 can range from about 1000 ppm to about 10,000 ppm, suitably about 2000 ppm to about 7500 ppm, depending on the amount of impurities in the PCRP blend and the respective amounts of recycled branched low density polyethylene and recycled linear low density polyethylene.

In accordance with the invention, a blooming slip agent can also be added to the polymer composition used to make the flexible sheet 20. The blooming slip agent improves the coefficient of friction between the internal aperture surfaces of the flexible sheet 20 and the containers, and helps offset any sticking or binding effects that might otherwise result from low molecular weight impurities in the PCRP bend and/or a low molecular weight compatibilizer. Suitable blooming slip agents include without limitation erucamide, which is a bio-based unsaturated primary amide that provides a high slip effect. Erucamide, which can be obtained from Cargill, is a primary fatty amide resulting from the formal condensation of the carboxyl group of erucic acid with ammonia. The blooming slip agent can be present in the polymer composition in an amount of about 100 ppm to about 3000 ppm, suitably about 1500 ppm to about 2000 ppm.

The polymer composition used to form the flexible sheet 20 can optionally include an antiblock agent and/or an antioxidant. One exemplary antiblock agent is nepheline syenite. The antiblock agent can be included at zero to about 2500 ppm, or about 1500 to about 2000 ppm. Suitable antioxidants include without limitation those based on phosphites, phenolics, and blends thereof. The antioxidant can be included at zero to about 5000 ppm, or about 1500 to about 2500 ppm.

While in the foregoing specification this invention has been described in relation to certain preferred embodiments thereof, and many details have been set forth for purpose of illustration, it will be apparent to those skilled in the art that flexible carrier 10 is susceptible to additional embodiments and that certain of the details described herein can be varied considerably without departing from the basic principles of the invention.

1. A flexible carrier for carrying a plurality of containers, comprising a flexible sheet and a plurality of primary apertures formed in the sheet for receiving portions of the containers, the flexible sheet comprising a polymer composition which includes:
about 97% to about 100% by weight of a PCRP blend that includes recycled branched low-density polyethylene and recycled linear low-density polyethylene polymers;
about 1000 ppm to about 10,000 ppm of a compatibilizer;
about 100 ppm about 3000 ppm of a blooming slip agent; and
zero to about 5000 ppm of an antioxidant; and
zero to about 2500 ppm of an antiblock agent.

2. The flexible carrier of claim 1, wherein the PCRP blend comprises about 40% to about 70% by weight of the recycled branched low density polyethylene and about 30% to about 60% by weight of the recycled linear low density polyethylene.

3. The flexible carrier of claim 1, wherein the PCRP blend comprises about 50% to about 60% by weight of the recycled branched low density polyethylene and about 40% to about 50% by weight of the recycled linear low density polyethylene.

4. The flexible carrier of claim 1, wherein the PCRP blend comprises about 60% to about 70% by weight of the recycled branched low density polyethylene and about 30% to about 40% by weight of the recycled linear low density polyethylene.

5. The flexible carrier of claim 1, wherein the flexible sheet comprises at least about 98% by weight of the PCRP blend.

6. The flexible carrier of claim 1, wherein the flexible sheet comprises at least about 99% by weight of the PCRP blend.

7. The flexible carrier of claim 1, wherein the compatibilizer comprises at least one of a polyamide, polypropylene, and anhydride-modified polyethylene.

8. The flexible carrier of claim 1, wherein the compatibilizer comprises polyamide 12.

9. The flexible carrier of claim 1, wherein the flexible sheet comprises about 2000 ppm to about 7500 ppm of the compatibilizer.

10. A flexible carrier for carrying a plurality of containers, comprising a flexible sheet and a plurality of primary apertures formed in the sheet for receiving portions of the containers, the flexible sheet comprising a polymer composition which includes:
about 98% to about 100% by weight of a PCRP blend that includes about 40% to about 70% by weight recycled branched low-density polyethylene and about 30% to about 60% by weight recycled linear low-density polyethylene, the recycled branched low-density polyethylene and recycled linear low-density polyethylene together constituting at least about 98% by weight of the PCRP blend;
about 1000 ppm to about 10,000 ppm of a compatibilizer;
about 100 ppm about 3000 ppm of a blooming slip agent; and
zero to about 5000 ppm of an antioxidant; and
zero to about 2500 ppm of an antiblock agent.

11. The flexible carrier of claim 10, wherein the compatibilizer comprises at least one of a polyamide, and polypropylene, and anhydride-modified polyethylene.

12. The flexible carrier of claim 10, wherein the compatibilizer comprises polyamide 12.

13. The flexible carrier of claim 10, wherein the blooming slip agent comprises erucamide and is present at about 1500 to about 2000 ppm of the flexible carrier.

14. The flexible carrier of claim 10, wherein the antiblock agent comprises nepheline syenite and is present at about 1500 to about 2000 ppm of the flexible carrier.

15. The flexible carrier of claim 10, wherein the recycled branched low-density polyethylene and recycled linear low-density polyethylene together constituting at least about 99% by weight of the PCRP blend.

16. The flexible carrier of claim 10, wherein the flexible carrier consists of the flexible sheet, the flexible sheet is a single-layer flexible sheet, and the flexible sheet includes a plurality of primary apertures having convex edges formed in the sheet for receiving portions of the containers by stretching the flexible carrier surrounding the primary apertures around the containers and allowing the flexible carrier surrounding the primary apertures to recover, providing a tight engagement with the containers within the primary apertures.

17. A flexible carrier for engaging and carrying a plurality of containers having a first diameter, the flexible carrier including a flexible sheet having a plurality of apertures having a second diameter that is smaller than the first diameter prior to the engaging, the flexible sheet comprising a polymer composition which includes:
about 97% to about 100% by weight of a PCRP blend that includes about 40% to about 70% by weight recycled branched low-density polyethylene and about 30% to about 60% by weight recycled linear low-density polyethylene;
about 1000 ppm to about 10,000 ppm of a compatibilizer selected from at least one of a polyamide, polypropylene, and anhydride-modified polyethylene;
about 100 ppm about 3000 ppm of a blooming slip agent; and
zero to about 5000 ppm of an antioxidant; and
zero to about 2500 ppm of an antiblock agent.

18. The flexible carrier of claim 17, wherein the PCRP blend comprises about 50% to about 60% by weight of the recycled branched low density polyethylene and about 40% to about 50% by weight of the recycled linear low density polyethylene.

19. The flexible carrier of claim 17, wherein the PCRP blend comprises about 60% to about 70% by weight of the recycled branched low density polyethylene and about 30% to about 40% by weight of the recycled linear low density polyethylene.

20. The flexible carrier of claim 17, wherein the flexible sheet comprises at least about 99% by weight of the PCRP blend.
